(19) United States
(12) Patent Application Publication
(10) Pub. No.: US 2012/0200185 A1
(43) Pub. Date: Aug. 9, 2012

(54) ROTOR FOR ROTARY ELECTRIC MACHINE AND MANUFACTURING METHOD THEREOF

(75) Inventors: Shinya SANO, Toyota-shi (JP); Yoshitada YAMAGISHI, Toyota-shi (JP); Yuta WATANABE, Nishio-shi (JP)

(73) Assignee: TOYOTA JIDOSHA KABUSHIKI KAISHA, Toyota-shi (JP)

(21) Appl. No.: 13/364,367

(22) Filed: Feb. 2, 2012

(30) Foreign Application Priority Data
Feb. 3, 2011 (JP) 2011-021478

(51) Int. Cl. H02K 1/17; H02K 15/03

(52) U.S. Cl. 310/156.01; 310/216.106; 29/598

(57) ABSTRACT

A rotor for a rotary electric machine includes a plurality of magnetic poles disposed at intervals in a circumferential direction, on an outer periphery of a rotor core that is a steel sheet stack that has a shaft hole in a central portion thereof configured so that a shaft is passed through and fixed to the shaft hole. The magnetic poles each have two permanent magnets and a magnetic flux suppression hole that regulates flow of magnetic flux from the permanent magnets, and are formed in such a manner that a shape of the magnetic flux suppression hole of at least one magnetic pole is different from a shape of the magnetic flux suppression hole of another magnetic poles, depending on the presence or absence of a positioning portion.

### INCORPORATION BY REFERENCE

The disclosure of Japanese Patent Application No. 2011-021478 filed on Feb. 3, 2011 including the specification, drawings and abstract is incorporated herein by reference in its entirety.

### BACKGROUND OF THE INVENTION

1. Field of the Invention

The invention relates to a rotor for a rotary electric machine and a manufacturing method thereof, and more particularly relates to a rotor for a rotary electric machine having a plurality of permanent magnets that are buried at intervals in a circumferential direction in the interior on the outer periphery side of a rotor core, and to a method of manufacturing the rotor for a rotary electric machine.

2. Description of Related Art

For example, Japanese Patent Application Publication No. 2005-124333 (JP-A-2005-124333) discloses a conventional rotor provided with a rotor core wherein a plurality of magnetic poles, each having two permanent magnets disposed in a Vshaped arrangement, are provided, evenly spaced, in a circumferential direction. A key protruding inward in a radial direction is provided at an edge portion of a shaft hole that is formed in a central portion of the cylindrical rotor core. When a shaft is passed through the shaft hole and fixed, this key fits a keyway that is formed, extending in the axial direction, on the surface of the shaft. The circumferential direction position of the rotor core with respect to the shaft is determined as a result.

In the rotor of JP-A-2005-124333, it is necessary to cut beforehand a keyway on the surface of the shaft that is made up of a steel bar. This is one factor that drives up manufacturing costs of the rotor.

Alternatively, the shaft may be fixed to the shaft hole of the rotor core not through key fitting, but by interference fitting (also referred to as shrink fitting). This is advantageous in that no keyway need be formed in the shaft, and manufacturing costs can be reduced proportionally. Since no key is provided now in the shaft hole of the rotor core, however, there is no portion that constitutes a circumferential direction reference upon assembly of the rotor core through stacking of a plurality of magnetic steel sheets that have been punched to a circular ringlike shape, and it is difficult to ensure precision upon stacking of the steel sheets.

### SUMMARY OF THE INVENTION

The invention provides a rotor for a rotary electric machine that enables performing circumferential direction positioning, with good precision, upon stacking of steel sheets, while doing without a positioning key for a shaft, and provides a method of manufacturing the rotor for a rotary electric machine.

A rotor for a rotary electric machine according to a first aspect of the invention includes a rotor core being a steel sheet stack that has a shaft hole in a central portion thereof configured so that a shaft is passed through and fixed to the shaft hole, the rotor core having a plurality of magnetic poles provided at intervals on an outer periphery thereof in a circumferential direction, each of the magnetic poles including a permanent magnet, and a magnetic flux suppression hole that regulates flow of magnetic flux from the permanent magnet, wherein a shape of the magnetic flux suppression hole of at least one magnetic pole is different from a shape of the magnetic flux suppression hole of another magnetic pole.

A method of manufacturing a rotor for a rotary electric machine according to a second aspect of the invention is a method of manufacturing a rotor for a rotary electric machine, the rotor including a plurality of magnetic poles each having a permanent magnet and a magnetic flux suppression hole, the magnetic poles being equidistantly provided in a circumferential direction on an outer periphery of a rotor core that is a steel sheet stack, the method having: assembling the rotor core by stacking a plurality of circular ringlike magnetic steel sheets each having a magnet insertion hole and a magnetic flux suppression hole formed therein, by using, as a reference, a positioning portion that is protrusively provided at an edge portion of the magnetic flux suppression hole; disposing a ferromagnetic body into the magnet insertion hole of the assembled rotor core; fixing a shaft to the rotor core having the ferromagnetic body disposed therein; fixing, by way of a mold resin, the ferromagnetic body in the rotor core that has the shaft fixed thereto; and setting the rotor core, having the shaft fixed thereto, in a magnetization device, and magnetizing the ferromagnetic body, to form the ferromagnetic body into a permanent magnet.

Forming the shape of the magnetic flux suppression hole of at least one magnetic pole to be different from the shape of the magnetic flux suppression holes of other magnetic poles in the rotor core that is made up of a steel sheet stack makes it possible to use the abovementioned one magnetic flux suppression hole of dissimilar shape as a reference site for circumferential direction positioning during stacking of the steel sheets. As a result, the rotor core can be assembled through stacking, with good precision, of the magnetic steel sheets, while the manufacturing cost of the rotor can be lowered by doing away with a key in the shaft hole and a keyway in the shaft.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a longitudinal section, taken along an axial direction, of a rotor for a rotary electric machine (hereafter, referred also simply as rotor) that is one embodiment of the invention;

FIG. 2 is a diagram illustrating an axial-direction end face of a rotor core that makes up the rotor of FIG. 1;

FIG. 3 is a partially enlarged view illustrating one magnetic pole in FIG. 2 in an enlarged manner; and

FIG. 4 is a flowchart illustrating a method of manufacturing a rotor in one embodiment of the invention.

### DETAILED DESCRIPTION OF EMBODIMENTS

Embodiments of the invention will be described in detail below with reference to accompanying drawings. In the description below, specific forms, materials, numerical values, directions and so forth are merely examples for facilitating comprehension of the invention, and can be appropriately modified depending on the intended application, purpose, specifications and the like.

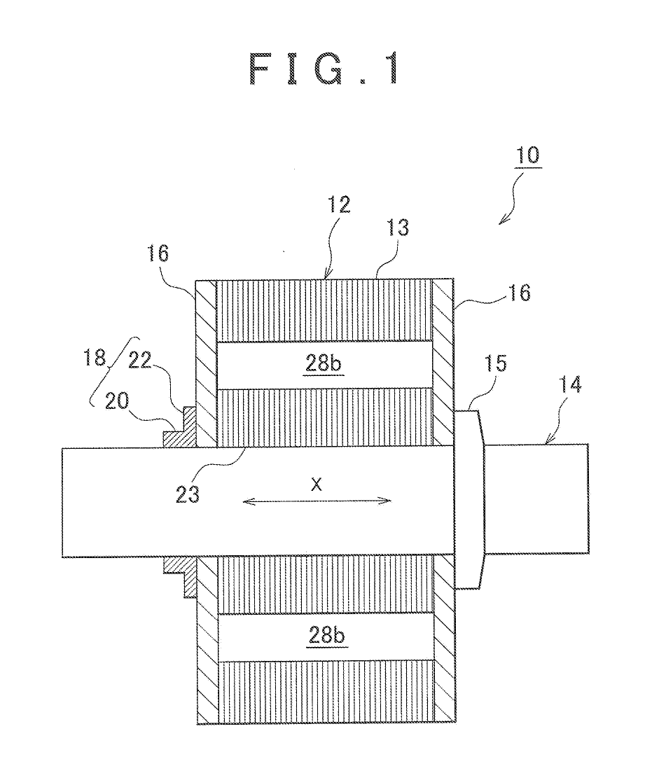

FIG. 1 illustrates a longitudinal section taken along an axial direction of a rotor for a rotary electric machine 10 of the present embodiment. A tubular stator (not shown) is provided around the rotor 10. The stator forms a magnetic field for rotational driving of the rotor 10.

The rotor 10 includes: a rotor core 12 having a cylindrical shape or a cylindrical shape with a central hole; a shaft 14 that is passed through the central hole of the rotor core 12 and fixed; end plates 16 that are disposed in contact with the rotor core 12, on both sides of the latter, in the axial direction of the shaft 14 (and the rotor core 12) denoted by arrow X; and a fixing member 18 that fixes the rotor core 12 and one of the end plates 16 to the shaft 14.

The rotor core 12 is configured through stacking, in the axial direction, of a plurality of magnetic steel sheets that are each formed through punching, into a circular ringlike shape, of, for example, 0.3 mm-thick silicon steel sheets or the like. The magnetic steel sheets that make up the rotor core 12 are integrally joined to each other by methods that involve crimping, bonding, welding or the like, of all sheets, collectively or by dividing the rotor core 12 into a plurality of blocks in the axial direction. A plurality of magnetic poles are provided, at equal spacings in the circumferential direction, on the rotor core 12. As explained in detail below, each magnetic pole has a plurality of permanent magnets and a magnetic flux suppression hole.

The shaft 14 is formed from a round steel bar. A flange portion 15 is formed on the outer periphery of the shaft 14, such that the flange portion 15 projects outwards in the radial direction. The flange portion functions as a stopper that determines the axial direction position of the rotor core 12 on the shaft 14, through abutment against the end plate 16 during assembly of the rotor 10. In the present embodiment, the rotor core 12 is fixed to the shaft 14 by interference fitting, and hence no keyway is formed on the outer surface of the shaft 14. As a result, no keyway need be cut into the shaft 14. This allows reducing the manufacturing costs of the shaft 14, and as a result, reducing those of the rotor 10.

The end plates 16 are made up of disks having substantially the same outer shape as that of the axial-direction end faces of the rotor core 12. More preferably, the end plates 16 are made of a non-magnetic metal material, for example aluminum, copper or the like. A non-magnetic metal material is used herein for the purpose of suppressing the short circuit of magnetic flux at the axial-direction end portions of the permanent magnets that make up the magnetic poles. Provided that the material thereof is a non-magnetic material, the end plates 16 are not limited to a metal material, and may be formed out of a resin material.

The end plates 16 provided on both ends of the rotor core 12 in the axial direction have, for example, a function of pressing the rotor core 12 from both ends, a function of correcting unbalance in the rotor 10 arising from partial cutting work after assembly of the rotor 10, and a function of preventing that the permanent magnets that make up the magnetic poles should come off the rotor core 12 in the axial direction.

In the present embodiment the end plates 16 are explained and depicted in the figures as having substantially the same diameter as the rotor core 12. However, the diameter of the end plates 16 may be for example made smaller, or the end plates 16 may be omitted, to cut costs, in a case where, for example, the permanent magnets that make up the magnetic poles are fixed to the interior of the rotor core by means of a resin or the like.

The fixing member 18 has a crimp portion 20 that has a tubular shape, and a pressing portion 22 that protrudes outwards in the radial direction from one end portion of the crimp portion 20. The fixing member 18 is fixed to a shaft 14 through crimping of the crimp portion 20 against the shaft 14, in a state where the rotor core 12 and the two end plates 16 are pressed against the flange portion 15 by the pressing portion 22. As a result, the rotor core 12 is fixed to the end plates 16 and the shaft 14.

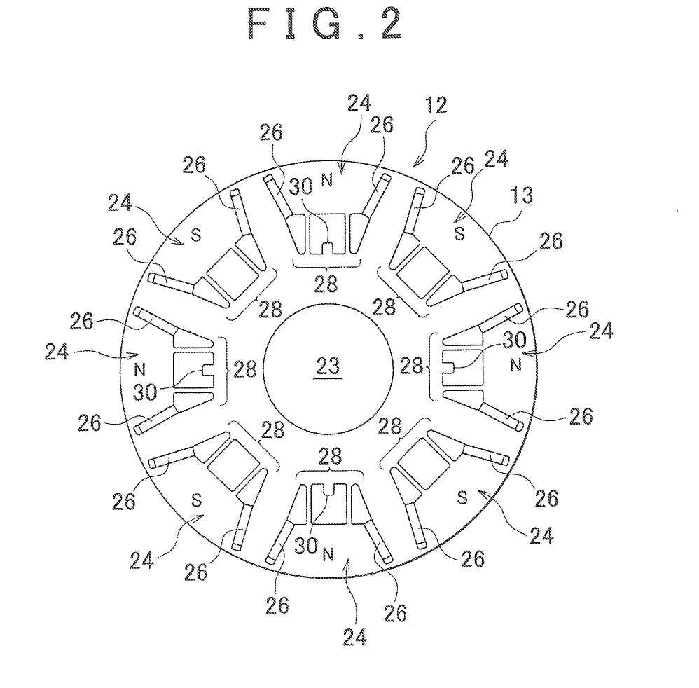

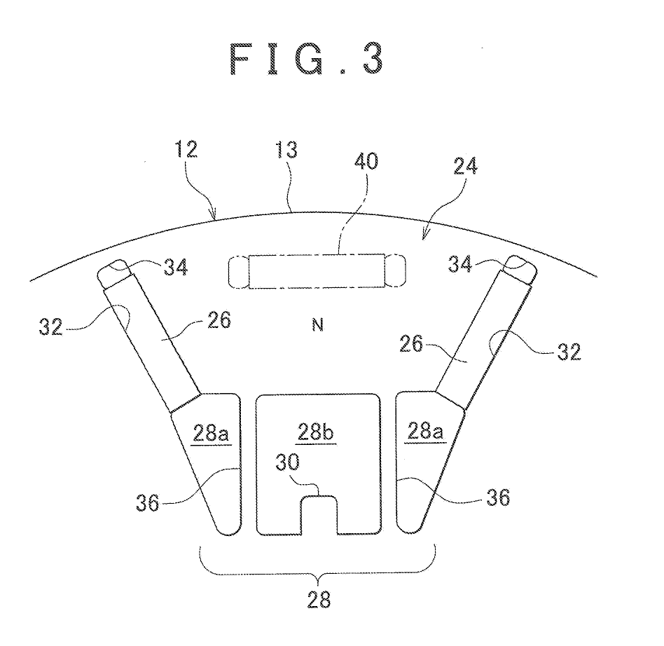

An explanation follows next on a configuration of the rotor core 12, with reference to FIGS. 2 and 3. FIG. 2 is a diagram illustrating an axial-direction end face of the rotor core 12, but the configuration of any cross section of the rotor core 12 that is perpendicular to the axial direction is identical to that of the figure. FIG. 3 is an enlarged view of one magnetic pole 24 of FIG. 2. The notations “N” and “S” in FIG. 2 denote the polarity of the magnetic poles after final magnetization of the permanent magnets, but such notations are not actually displayed on the end faces of the rotor core 12.

A shaft hole 23, for insertion and fixing of the shaft 14, is formed through the central portion of the rotor core 12 that has a cylindrical outer shape. As described above, the shaft hole 23 is circular and has no key formed at the edge portion thereof.

A plurality (eight in the present embodiment) of magnetic poles 24 are provided, equally spaced in the circumferential direction, at the outer periphery of the rotor core 12. Each magnetic pole 24 has two permanent magnets 26 and a magnetic flux suppression hole 28. Each permanent magnet 26 is buried inside the rotor core 12, in the vicinity of an outer peripheral face 13. A positioning portion 30 is provided in one of the magnetic flux suppression holes 28 of the magnetic poles 24 corresponding to N poles. The shape of the magnetic flux suppression hole 28 of the above one magnetic pole 24 differs from the shape of the magnetic flux suppression hole 28 of other magnetic poles 24 depending on the presence or absence of the positioning portion 30. The configurations of the N magnetic poles and the S magnetic poles are identical, except for the positioning portion 30.

With reference to FIG. 3, two permanent magnets 26 are provided in one magnetic pole 24. The two permanent magnets 26 have the same size and shape. Specifically, the permanent magnets 26 are formed to have substantially the same axial-direction length as that of the rotor core 12, and so as to have an elongated rectangular axial-direction end face (and cross section) each having a two short sides and two long sides. The permanent magnets 26 are magnetized in the thickness direction along the short-side lateral face. In the example of FIG. 3, the inner, opposing face sides of the two permanent magnets 26 are magnetized to an N pole and the outer, back sides of the two permanent magnets 26 are magnetized to S poles.

The two permanent magnets 26 are inserted into respective magnet insertion holes 32, to be fixed and buried in the magnetic pole 24. As a result, the two permanent magnets 26 become disposed in the form of a substantially V shape, or the kanji character representing “eight”, in which the spacing between the magnets widens towards the outer peripheral face 13 of the rotor core 12. The permanent magnets 26 are inserted, from the axial direction, into the magnet insertion holes 32 that are formed in the rotor core 12, and are fixed for example by means of a thermosetting resin that is injected into the narrow gaps formed between the hole inner wall face and the long-side lateral faces of the permanent magnets 26. The permanent magnets 26 are disposed in a position such that the short-side lateral faces thereof extend substantially along the outer peripheral face 13 of the rotor core 12.

A pocket portion 34 that communicates with the magnet insertion hole 32 is formed at the outer periphery side of each magnet insertion hole 32. The pocket portion 34 is formed extending in the axial direction along the short-side lateral face of the permanent magnet 26. The pocket portion 34 has, in the interior thereof, a void of lower permeability than that of the magnetic steel sheets. Therefore, the pocket portion 34 has the function of suppressing the short circuit of magnetic flux at the outer periphery end portion of the permanent magnet 26 in the longitudinal direction. The resin for fixing the permanent magnets 26 may be injected, via the pocket portions 34, between the inner wall face of the magnet insertion holes 32 and the long-side lateral faces of the permanent magnets 26.

The above-described magnetic flux suppression holes 28 are formed each at a position close to the inner periphery (bottom of FIG. 3), between inner peripheryside end portions of the two permanent magnets 26 in the magnetic pole 24. The magnetic flux suppression holes 28 have, in the interior thereof, a void section of lower permeability than that of the magnetic steel sheets. Therefore, the magnetic flux suppression holes 28 have the function of suppressing, or altering, the flow of magnetic flux that is generated by the permanent magnets 26 (as well as the magnetic flux that penetrates into the rotor core from the stator, not shown).

In the present embodiment, each magnetic flux suppression hole 28 is made up of two first holes 28a and one second hole 28b. The first holes 28a are formed communicating with the inner peripheryside end portion of the magnet insertion holes 32 through which the permanent magnets 26 are inserted. The first holes 28a are formed so as to have mirrorsymmetrical substantially triangular shapes. The first holes 28a have the function of suppressing the short circuit of magnetic flux at the longitudinal direction end portion of the permanent magnets 26, on the inner periphery side. The resin for fixing the permanent magnets 26 may be injected into the magnet insertion holes 32 via the first holes 28a.

A substantially rectangular second hole 28b is formed between the first holes 28a with bridge portions 36 interposed between the second hole 28b and the first holes 28a. Each second hole 28b is opposed to the outer peripheral face 13 at a middle position between two permanent magnets 26 in the circumferential direction. The second hole as well has, in the interior thereof, a void section of lower permeability than that of the magnetic steel sheets. Therefore, the second hole has the function of orienting the magnetic flux generated at the opposing face side (i.e. N pole side) of the permanent magnets 26 towards the outer periphery. The second hole can also keep small the daxis inductance Ld at a central position, in the circumferential direction, of the magnetic pole 24. As a result, it becomes possible to effectively increase the total torque, i.e. the sum of magnet torque and reluctance torque, in the rotary electric machine that uses the rotor 10.

The positioning portion 30 is formed, at the inner periphery side edge portion of the second hole 28b, as a small rectangle that protrudes towards the outer periphery. The positioning portion 30 is formed at each magnetic steel sheet that makes up the rotor core 12. As a result, the magnetic steel sheets can be positioned with good precision in the circumferential direction, and then stacked, by using the positioning portion 30 (instead of a key of a conventional shaft hole) as a reference during assembly of the rotor core 12 through stacking of the magnetic steel sheets in the axial direction.

Preferably, the positioning portion 30 is formed at the inner periphery side edge portion of the second hole 28b. This is because if the positioning portion 30 is formed at the outer peripheryside edge portion of the second hole 28b, daxis inductance Ld increases, which can lead to a drop in the reluctance torque. A further reason is that if the positioning portion 30 is formed at the bridge portions 36, which are circumferential direction edge portions of the second hole 28b, the precision of circumferential direction positioning of the rotor core 12, which is performed later with reference to the positioning portion, may be lost when distortion of the bridge portions 36 occurs as a result of injection pressure upon injection of the mold resin into the first holes.

In the present embodiment, the positioning portion 30 is provided at one magnetic pole 24 from among the eight magnetic poles 24. A predefined number of magnetic steel sheets are stacked in the same direction, to form four splitblock rotor core portions, the four splitblock rotor core portions are stacked, offset from one another by 90° in the circumferential direction, and are joined, to yield an assembly wherein the positioning portions 30 can be seen at 90° intervals, as illustrated in FIG. 2. Performing stacking in this way allows eliminating a combined axial-direction length error in the outer periphery of the rotor core 12 that arises from thickness errors of the magnetic steel sheets. The magnetic poles 24 having the visible positioning portion 30 can thus be easily recognized, even with no indication to the effect that they are N magnetic poles.

An example has been explained in the present embodiment in which the positioning portion is provided at only one magnetic pole from among the plurality of magnetic poles. However, the embodiment is not limited thereto, and the positioning portion may be provided at two or more magnetic poles.

In the rotor 10 of the present embodiment, as described above, the shape of a magnetic flux suppression hole 28 of one magnetic pole 24 in the rotor core 12, which has a steel sheet stack, is formed differently, by virtue of the presence of the positioning portion 30, from the shape of the magnetic flux suppression hole 28 of other magnetic poles 24. It therefore becomes possible to use the abovementioned one magnetic flux suppression hole 28, having a different shape, as a circumferential direction positioning site upon stacking of the steel sheets. As a result, the rotor core 12 can be assembled through stacking, with good precision, of the magnetic steel sheets, while the manufacturing cost of the rotor 10 can be lowered by doing away with a key in the shaft hole 23 and a keyway in the shaft 14.

Drops in centrifugal resistance strength and torque resistance strength in the magnetic pole portion of the rotor core 12 can be suppressed by thus configuring the magnetic flux suppression holes 28, as described above, by three holes 28a, 28a, 28b that include two bridge portions 36.

The positioning portion 30 can be used for determining, using a fixture, the circumferential direction position of the rotor core 12 in a molding mold, during fixing of the permanent magnets 26 by a mold resin.

If the rotor core 12 is cooled through flow of cooling oil through the second hole 28b, then the contact surface area with the cooling oil increases because of the presence of the positioning portion. This allows enhancing the cooling efficiency.

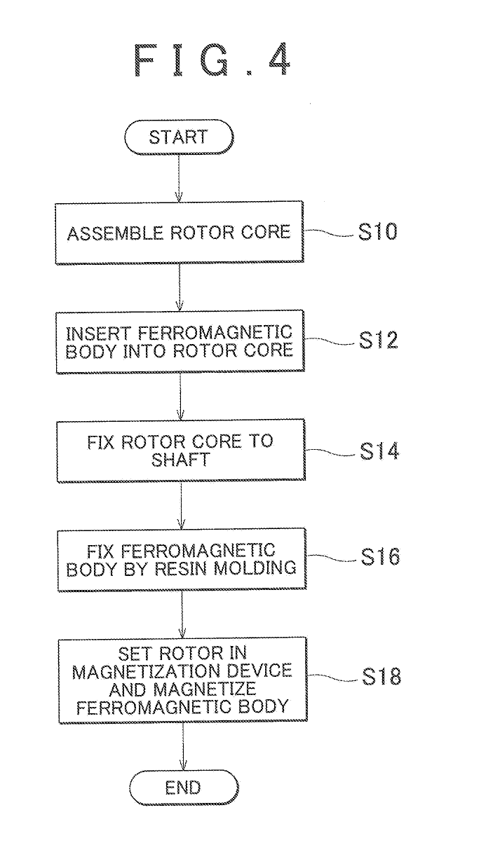

A method of manufacturing the rotor 10 will be described next with reference to FIG. 4.

Firstly, the rotor core 12 is assembled in step S10. The magnetic steel sheets having one positioning portion formed as described above are stacked in the axial direction while being positioned precisely in the circumferential direction, and are then integrally joined to each other.

In step S12, a ferromagnetic body is inserted next into the rotor core 12. The ferromagnetic body serves as a magnet intermediate body before magnetization.

In step S14, next, the rotor core 12 is fixed to the shaft 14. Herein, the rotor core 12 is fixed by being attached to the shaft 14 by interference fitting or shrink fitting. At this time, the magnet intermediate body is at a stage before magnetization, and hence the problem of thermal demagnetization does not occur.

Thereafter, in step S16, the ferromagnetic body in the rotor core 12 fixed to the shaft 14 is fixed by way of a mold resin. As in the case above, the magnet intermediate body is at a stage before magnetization, and hence, the problem of thermal demagnetization does not occur upon thermal curing of the resin, if a thermosetting resin is used as the mold resin.

In step S18, the rotor core 12 fixed to the shaft 14 is set inside a magnetization device, and the abovementioned ferromagnetic body is magnetized, to yield the permanent magnets 26. In the present embodiment, the positioning portion 30 is provided for a magnetic pole 24 that corresponds to an N pole. Therefore, the rotor core 12 can be accurately set in the magnetization device while checking the circumferential direction position by referring to the positioning portion 30. The permanent magnets 26 become thus magnetized, to complete the manufacture of the rotor 10.

Various modifications and improvements of the embodiment having the above-described configuration can be made. In the explanation above, for example, two permanent magnets 26 are included in one magnetic pole 24, but alternatively, three permanent magnets may be included in one magnetic pole, through burying of another permanent magnet 40 at a position in the vicinity of the outer peripheral face 13, the position being a central position in the circumferential direction of the magnetic pole 24, as indicated by the dashed line in FIG. 3. Alternatively, four or more permanent magnets may be included in one magnetic pole.

In the explanation above, a positioning portion 30 that is one rectangular protrusion is provided in one magnetic pole 24. However, the shape of the positioning portion and the number of positioning portions per one magnetic pole may be modified as appropriate. Likewise, the shape and number of holes that make up the magnetic flux suppression hole may be modified as appropriate.

In the explanation of the embodiment above, the positioning portion is configured as a protrusion formed at a hole edge portion, but the positioning portion may be configured as a recess or notch formed in the hole edge portion.

In the rotor for a rotary electric machine, a positioning portion that determines the position of the rotor core in a circumferential direction may be protrusively provided at an edge portion of the magnetic flux suppression hole of the at least one magnetic pole.

In the rotor for a rotary electric machine, the positioning portion may be provided at an edge portion of an inner periphery side of the magnetic flux suppression hole, in a radial direction of the rotor core, so as to protrude outwards in the radial direction.

In the rotor for a rotary electric machine, each magnetic pole may have two permanent magnets that are disposed in such a manner that a spacing therebetween widens towards an outer periphery in the radial direction of the rotor core; and the magnetic flux suppression hole may be formed at a position close to an inner periphery side, between end portions of the two permanent magnets on an inner periphery side in the radial direction, and may have two substantially triangular first holes that communicate with magnet insertion holes for insertion of the permanent magnets into the rotor core, and a substantially rectangular second hole formed between the two first holes with bridge portions interposed between the second hole and the first holes.

In the above method of manufacturing a rotor for a rotary electric machine, in the setting the rotor core in the magnetization device, a circumferential direction position of the rotor core may be determined using the positioning portion.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

What is claimed is:

1. A rotor for a rotary electric machine, comprising:
a rotor core being a steel sheet stack that has a shaft hole in a central portion thereof configured so that a shaft is passed through and fixed to the shaft hole, the rotor core having a plurality of magnetic poles provided at intervals on an outer periphery thereof in a circumferential direction, each of the magnetic poles including a permanent magnet and a magnetic flux suppression hole that regulates flow of magnetic flux from the permanent magnet, wherein
a shape of the magnetic flux suppression hole of at least one magnetic pole is different from a shape of the magnetic flux suppression hole of another magnetic pole.

2. The rotor for a rotary electric machine according to claim 1, wherein a positioning portion that determines a position of the rotor core in the circumferential direction is protrusively provided at an edge portion of the magnetic flux suppression hole of the at least one magnetic pole.

3. The rotor for a rotary electric machine according to claim 2, wherein the positioning portion is provided at an edge portion of an inner periphery side of the magnetic flux suppression hole, in a radial direction of the rotor core, so as to protrude outwards in the radial direction.

4. The rotor for a rotary electric machine according to claim 1, wherein
each of the magnetic poles includes two permanent magnets that are disposed in such a manner that a spacing therebetween widens towards an outer periphery in the radial direction of the rotor core, and
the magnetic flux suppression hole is formed at a position close to an inner periphery side in the radial direction and between end portions of the two permanent magnets on the inner periphery side in the radial direction, and includes two substantially triangular first holes that communicate with magnet insertion holes for insertion of the permanent magnets into the rotor core, and a substantially rectangular second hole formed between the two first holes with bridge portions interposed between the second hole and the first holes.

5. A method of manufacturing a rotor for a rotary electric machine, the rotor including a plurality of magnetic poles each having a permanent magnet and a magnetic flux suppression hole, the magnetic poles being equidistantly provided in a circumferential direction on an outer periphery of a rotor core that is a steel sheet stack, the method comprising:
assembling the rotor core by stacking a plurality of circular ringlike magnetic steel sheets each having a magnet insertion hole and a magnetic flux suppression hole formed therein, by using, as a reference, a positioning portion that is protrusively provided at an edge portion of the magnetic flux suppression hole;
disposing a ferromagnetic body into the magnet insertion hole of the assembled rotor core;
fixing a shaft to the rotor core having the ferromagnetic body disposed therein;
fixing, by way of a mold resin, the ferromagnetic body in the rotor core that has the shaft fixed thereto; and
setting the rotor core, having the shaft fixed thereto, in a magnetization device, and magnetizing the ferromagnetic body, to form the ferromagnetic body into a permanent magnet.

6. The method of manufacturing a rotor for a rotary electric machine according to claim 5, wherein, in the setting the rotor core in the magnetization device, a circumferential direction position of the rotor core is determined using the positioning portion.
